(19) United States
(12) Patent Application Publication
(10) Pub. No.: US 2006/0061803 A1
(43) Pub. Date: Mar. 23, 2006

(54) Image forming system and communication method

(75) Inventor: Tomohide Oka, Shizuoka-ken (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Chiyoda-ku (JP)

(21) Appl. No.: 10/945,745

(22) Filed: Sep. 20, 2004

(51) Int. Cl. G06F 3/12

(52) U.S. Cl. 358/1.15

(57) ABSTRACT

A main CPU of an MFP reads out an IP address or URL of a relay server on the Internet, which is set in an HDD, and connects to the relay server via a firewall using https. The main CPU confirms security of the relay server on the basis of a server certificate. A PC on the Internet accesses the relay server on the Internet, establishes SSL connection, and sends a client certificate. The relay server receives the client certificate from the PC by SSL connection, and sends a server certificate to the PC. If mutual authentication is successfully executed, the PC sends data to the MFP via the relay server and executes such a job as print data transmission, scan data acquisition, or change of setting information.

### BACKGROUND OF THE INVENTION

1. Field of the Invention

The present invention relates to an image forming system including an image forming apparatus that is connected to an intranet and the Internet and forms an image, and to a communication method.

2. Description of the Related Art

In the prior art, for example, a plurality of personal computers (PCs) are connected to a digital multi-function peripheral (MFP). Thus, an intranet is constructed, and printing is executed. In a case where the intranet is connected to the Internet, a firewall is provided at a connection point therebetween.

Jpn. Pat. Appln. KOKAT Publication No. 11-234271 discloses a remote fault management system using the Internet. This is a remote fault management system using the Internet for a multi-function peripheral on a network. This system realizes a function of immediately reporting fault information to a management server via an existing intranet or the Internet, when a fault occurs in a networked device that is connected to the intranet in a company. This system includes a networked device that reports the fault information using HTTP, means for reporting the fault information to a management server in the intranet using the HTTP, and means for reporting the fault information to an external management server using the HTTP through a security system that is provided outside the intranet.

In other words, a terminal device in an intranet reports fault information to a management server on the Internet, which is located outside a firewall, using HTTP.

Jpn. Pat. Appln. KOKAI Publication No. 2003-167802 discloses a dual server system and servers used therein. Information relating to a fault of a device is provided from a Web server system, which is connected to the Internet via a firewall, to a client. In addition, past results of repairs are collected from clients, and a management server system, which is connected to the Web server system via the firewall, acquires the past results of repairs that are collected by the Web server system. Furthermore, fault diagnosis data, which is adjusted based on the past results of repairs, is provided to the Web server system 40.

In short, using the two servers that are provided via the firewall, necessary information is shared by the PCs on the intranet and the Internet.

Jpn. Pat. Appln. KOKAI Publication No. 2001-154953 discloses a network system and a communication method. The network system and communication method enable necessary data communication between an intranet-side device that is an object of communication, which is protected by a firewall, and a management apparatus that is connected via the Internet. The network system executes data communication between the communication-object device, which is connected to an internal network that connects to an external network via a firewall that passes only a signal according to a specified communication protocol, and the management apparatus that connects to the external network and operates the communication-object device or monitors the operation of the communication-object device. In this structure, the communication-object device adds data to a request according to the specified communication protocol, and sends the request to the management apparatus.

In the above case where the intranet is connected to the Internet, however, the firewall is provided at the connection point therebetween. Consequently, the above-mentioned PC can use the MFP only within the intranet, and a PC on the Internet cannot access the MFP in the intranet to acquire documents from the MFP.

In order to realize this, a VPN needs to be used in usual cases. The introduction of the system, however, requires provision of expensive devices and installation of VPN software in each client. This also requires expertise.

### BRIEF SUMMARY OF THE INVENTION

The object of an aspect of the present invention is to provide an image forming system and a communication method, wherein the image forming system is constructed such that an intranet in which a personal computer and an image forming apparatus are connected to a bus is connected to the Internet via a firewall, and the image forming apparatus can be accessed via the Internet that is present outside the firewall.

According to an aspect of the present invention, there is provided an image forming system in which the Internet is connected via a firewall to an intranet that is constructed such that a terminal device and an image forming apparatus are connected over a bus, the system comprising: a terminal device that is connected to the Internet and is previously in a state of connection to the image forming apparatus in the intranet; and a relay device that is connected to the Internet, the image forming apparatus comprising: control means for executing a control to connect to the relay device via the bus, the firewall and the Internet; and transmission means for sending authentication information of the terminal device in the intranet to the relay device, when the control means connects to the relay device, and the relay device comprising: registration means for registering the authentication information of the terminal device, which is sent from the transmission means; request means for requesting, upon receiving a connection request from the terminal device that is connected to the Internet, transmission of authentication information from the terminal device that is connected to the Internet; authentication means for authenticating the terminal device using the authentication information of the terminal device, which is registered in the registration means, when the authentication information of the terminal device is received in response to the request by the request means; and relay means for relaying communication between the image forming apparatus and the terminal device when the authentication of the terminal device is successfully executed by the authentication means.

According to another aspect of the present invention, there is provided a communication method for an image forming system in which the Internet is connected via a firewall to an intranet that is constructed such that a personal computer and an image forming apparatus are connected over a bus, the method comprising: providing a personal computer that is connected to the Internet and is previously in a state of connection to the image forming apparatus in the intranet, and a relay server that is connected to the Internet; causing the image forming apparatus to connect to the relay server via the bus, the firewall and the Internet, and to send authentication information of the personal computer in the intranet to the relay server; causing the relay server to register the authentication information of the personal computer, which is sent from the image forming apparatus; requesting, upon receiving a connection request from the personal computer that is connected to the Internet, transmission of authentication information from the personal computer that is connected to the Internet; authenticating the personal computer using the authentication information of the personal computer, which is registered, when the authentication information of the personal computer is received; and relaying communication between the image forming apparatus and the personal computer when the authentication of the personal computer is successfully executed.

Additional objects and advantages of an aspect of the invention will be set forth in the description which follows, and in part will be obvious from the description, or may be learned by practice of the invention. The objects and advantages of an aspect of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently embodiments of the invention, and together with the general description given above and the detailed description of the embodiments given below, serve to explain the principles of an aspect of the invention.

FIG. 1 is a block diagram that schematically shows the structure of a system using a digital multi-function peripheral according to the present invention;

FIG. 2 schematically shows the structure of the digital multi-function peripheral; and

FIG. 3 illustrates a process sequence of an operation in which a PC that is connected to the Internet connects to the MFP.

### DETAILED DESCRIPTION OF THE INVENTION

An embodiment of the present invention will now be described with reference to the accompanying drawings.

FIG. 1 schematically shows the structure of a system using a digital multi-function peripheral (MFP) 1 according to the present invention. A personal computer (PC) 2 that serves as a client is connected to the MFP 1 via a bus 4, thus constituting an intranet 5. The intranet 5 is connected to the Internet 7 via a firewall 6 that is connected to the bus 4. A relay server 8, which is to be described later in detail, is connected to the Internet 7. In addition, a PC 3 that serves as a client, which is previously in a state of connection to the MFP 1 in the intranet 5 via the bus 4, is connected to the Internet 5.

The personal computer 2, 3 is an ordinary PC including a CPU, a ROM, a RAM and an external interface.

The relay server 8 is an ordinary server including a CPU and a storage device.

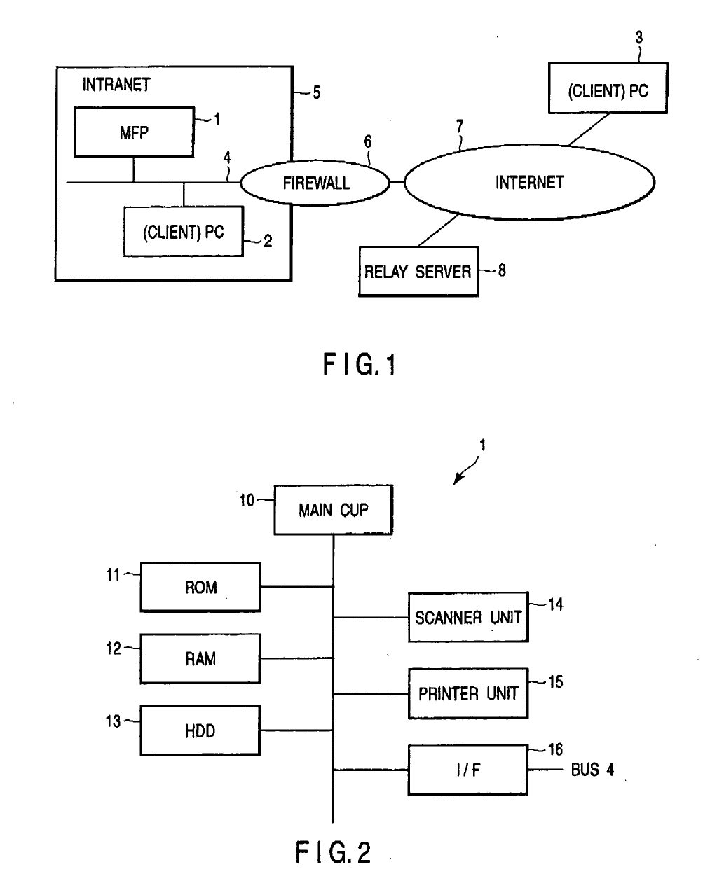

FIG. 2 schematically shows the structure of the MFP 1. The MFP 1 comprises a main CPU 10 that executes an overall control, a ROM 11 that stores a control program, etc., a RAM 12 that stores data, a hard disk drive (HDD) 13 that stores image data, etc., a scanner unit 14 that reads an image on an original, a printer unit 15 that outputs an image on the basis of the image data, and an interface (I/F) 16 that connects to the bus 4.

In the intranet 5, direct communication between the MFP 1 and the PC 2 is executed using ordinary http. Since the MFP 1 is provided in the intranet 5, a log-in prompt is displayed to the PC 2 that accesses the MFP 1 for the purpose of security, and input of pre-issued and registered “user ID” and “password,” is requested. Thus, the authentication of the client is executed.

Accordingly, when the PC 3 was in a state of connection to the bus 4 in the intranet 5, the authentication of the client was executed using the pre-issued and registered “user ID” and “password” that were made in association with the MFP 1.

In order to execute data relay, as described above, the relay server 8 is provided on the Internet 7. Since the relay server 8 is provided on the Internet 7, it normally uses a formal server certificate that is issued by a public CA.

The HDD 13 of the MFP 1 prestores the IP address or URL of the relay server 8 on the Internet 7.

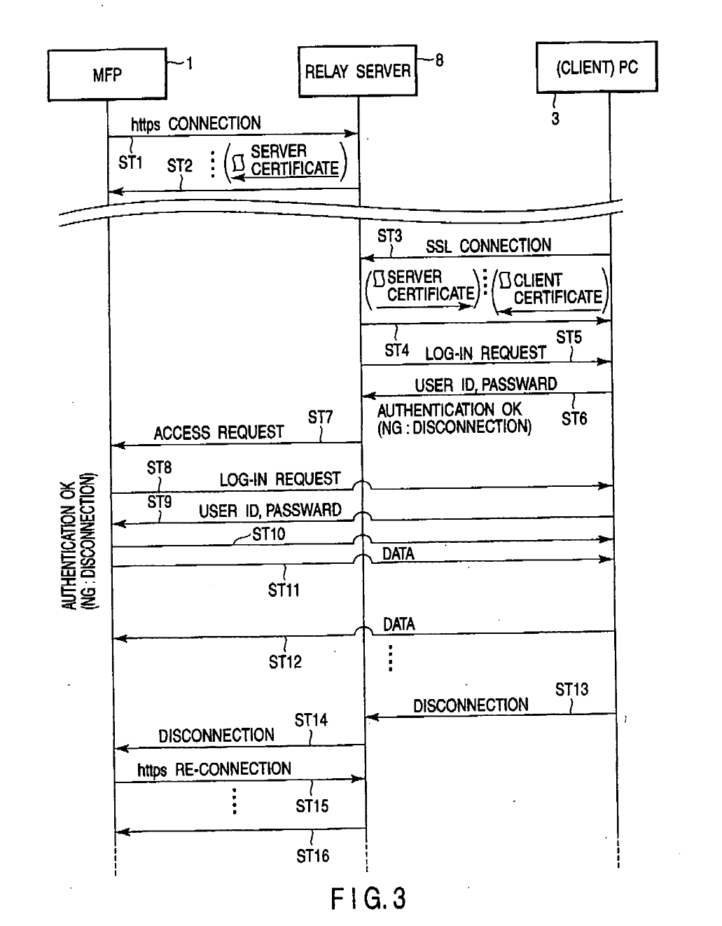

Next, referring to a process sequence of FIG. 3, a description is given of the operation in which the PC 3 that is connected to the Internet 7 connects to the MFP 1 in the above-described configuration.

The main CPU 10 of the MFP 1 reads out the IP address or URL of the relay server 8 on the Internet 7, which is set in the HDD 13, and connects to the relay server 8 via the firewall 6 using https (ST1).

The relay server 8 establishes connection to the MFP 1 using https, and sends a server certificate to the MFP 1 (ST2).

The main CPU 10 of the MFP 1 gives credit to the relay server 8 on the basis of the server certificate.

The relay server 8 acquires information from the connected MFP 1 and registers the information on a table (not shown) in order to determine an access from the client PC 3, which is to be relayed and transferred to the MFP 1.

The PC 3 on the Internet 7 accesses the relay server 8 on the Internet 7, establishes SSL connection, and sends a client certificate (ST3).

The relay server 8 receives the client certificate from the PC 3 by SSL connection, and sends a server certificate to the PC 3 (ST4).

The PC 3 gives credit to the relay server B on the basis of the server certificate.

After the https connection, the relay server 8 displays a log-in prompt, where necessary, and requests input of the pre-issued and registered “user ID” and “password” (ST5).

The PC 3 receives the log-in request from the relay server 8, and sends the “user ID” and “password” to the relay server 8 (ST6).

If the client authentication is successfully executed based an the “user ID” and “password,” the relay server 8 advances to the next step. If not, the relay server 8 executes disconnection.

If the authentication is successfully made, the relay server 8 specifies an MFP to be relayed, on the basis of the information from the client (PC3), and relays and transfers the access to the specified MFP in the intranet. The MFP to be relayed can be specified by the following methods. According to the methods, a pre-provided table is referred to, and the MFP to be relayed is specified.
a) To specify the MFP on the basis of the URL that is associated with the access.
b) To specify the MFP on the basis of the certificate that is sent at the time of the client authentication.
c) To specify the MFP on the basis of the user ID and password, which are sent at the time of the client authentication.

The relay server 8 sends an access request to the specified MFP 1 (ST7).

Specifically, the relay server 8 relays and transfers the access from the client (PC3) to the specified MFP 1. Thereafter, the relay server 8 executes only a relay operation and has nothing to do with data transmission between the client (PC3) and the MFP 1.

The main CPU 10 of the MFP 1 sends a response to the client (PC3) via the relay server 8, in the same manner as in the intranet 5.

For security, the main CPU 10 of the MFP 1 displays a log-in prompt to the client PC3 that has accessed the MFP 1, and requests input of the pre-issued and registered “user ID” and “password” (ST8).

Upon receiving the log-in request from the MFP 1, the PC3 sends the “user ID” and “password” to the MFP 1 (ST9).

If the client authentication is successfully executed based on the “user ID” and “password”, the main CPU 10 of the MEP 1 advances to the next step (ST10).

If the authentication fails, the main CPU 10 of the MFP 1 executes disconnection (ST11).

Assume now that the authentication is successfully executed in step ST10.

The PC 3 sends data to the MFP 1 and executes such a job as print data transmission, scan data acquisition, or change of setting information (ST12).

If the job is completed, the PC 3 sends a disconnection signal to the relay server 8 (ST13).

Upon receiving the disconnection signal from the PC 3, the relay server 8 sends a disconnection signal to the MFP 1 (ST14)

Upon receiving the disconnection signal from the relay server 8, the main CPU 10 of the MFP 1 cuts off the connection to the relay server 8.

If re-connection is to be established, the main CPU 10 of the MFP 1 reads out the IP address or URL of the relay server 8 on the Internet 7, which is set in the HDD 13, and establishes re-connection to the relay server 8 via the firewall 6 using https (ST15).

The relay server 8 establishes connection to the MFP 1 using the https, and sends a server certificate to the MEP 1 (ST16).

As has been described above, according to the embodiment of the invention, with only the provision of the relay server on the Internet, the client PC can use the MFP in the intranet from the Internet, like within the intranet, without the need to provide a special device or to install software in the client PC.

In the prior art, it is not possible to acquire/set information by communicating with a communication device in the intranet from the Internet. According to the invention, only by providing a single relay server on the Internet, can the communication with the intranet be realized without providing a server within the firewall of the intranet.

In addition, there is no need to specify the client PC on the Internet, which is communicable.

Furthermore, it is possible to provide security to prevent access from a number of non-specified client PCs.

It is also possible to provide communication security that is not affected by a security hole of the relay server.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image forming system in which the Internet is connected via a firewall to an intranet that is constructed such that a terminal device and an image forming apparatus are connected over a bus, the system comprising:
a terminal device that is connected to the Internet and is previously in a state of connection to the image forming apparatus in the intranet; and
a relay device that is connected to the Internet, the image forming apparatus comprising:
control means for executing a control to connect to the relay device via the bus, the firewall and the Internet; and
transmission means for sending authentication information of the terminal device in the intranet to the relay device, when the control means connects to the relay device, and
the relay device comprising:
registration means for registering the authentication information of the terminal device, which is sent from the transmission means;
request means for requesting, upon receiving a connection request from the terminal device that is connected to the Internet, transmission of authentication information from the terminal device that is connected to the Internet;
authentication means for authenticating the terminal device using the authentication information of the terminal device, which is registered in the registration means, when the authentication information of the terminal device is received in response to the request by the request means; and
relay means for relaying communication between the image forming apparatus and the terminal device when the authentication of the terminal device is successfully executed by the authentication means.

2. The image forming system according to claim 1, wherein the terminal device is a personal computer.

3. The image forming system according to claim 1, wherein while the terminal device, which is previously is in the state of connection to the image forming apparatus in the intranet, was being connected to the intranet, the authentication information of the terminal device is pre-registered in the image forming apparatus and is authenticated.

4. The image forming system according to claim 1, wherein the control means executes the control to connect to the relay device using a preset address or a preset URL of the relay device.

5. The image forming system according to claim 1, wherein the control means confirms security by acquiring a certificate that is possessed by the relay device, when the control means connects to the relay device.

6. The image forming system according to claim 1, wherein the transmission means sends to the relay device the authentication information of the terminal device in the intranet, in response to a request signal from the relay device.

7. The image forming system according to claim 1, wherein the relay means executes only relay of data that is transmitted between the terminal device and the image forming apparatus.

8. An image forming system in which the Internet is connected via a firewall to an intranet that is constructed such that a personal computer and an image forming apparatus are connected over a bus, the system comprising:
a personal computer that is connected to the Internet and in previously in a state of connection to the image forming apparatus in the intranet; and
a relay server that is connected to the Internet, the image forming apparatus comprising, a control unit that executes a control to connect to the relay server via the bus, the firewall and the Internet; and
a transmission control unit that executes a control to send authentication information of the personal computer in the intranet to the relay server, when the control unit connects to the relay server, and
the relay server comprising:
a table that registers the authentication information of the personal computer, which is sent from the transmission control unit;
an information request unit that requests, upon receiving a connection request from the personal computer that is connected to the Internet, transmission of authentication information from the personal computer that is connected to the Internet;
an authentication unit that authenticates the personal computer using the authentication information of the personal computer, which is registered in the table, when the authentication information of the personal computer is received in response to the request by the information request unit; and
a relay unit that relays communication between the image forming apparatus and the personal computer when the authentication of the personal computer is successfully executed by the authentication unit.

9. A communication method for an image forming system in which the Internet is connected via a firewall to an intranet that is constructed such that a personal computer and an image forming apparatus are connected over a bus, the method comprising:
providing a personal computer that is connected to the Internet and is previously in a state of connection to the image forming apparatus in the intranet, and a relay server that is connected to the Internet;
causing the image forming apparatus to connect to the relay server via the bus, the firewall and the Internet, and to send authentication information of the personal computer in the intranet to the relay server;
causing the relay server to register the authentication information of the personal computer, which is sent from the image forming apparatus;
requesting, upon receiving a connection request from the personal computer that is connected to the Internet, transmission of authentication information from the personal computer that is connected to the Internet;
authenticating the personal computer using the authentication information of the personal computer, which is registered, when the authentication information of the personal computer is received; and
relaying communication between the image forming apparatus and the personal computer when the authentication of the personal computer is successfully executed.
